(19) United States
(12) Patent Application Publication
(10) Pub. No.: US 2006/0176350 A1
(43) Pub. Date: Aug. 10, 2006

(54) Replacement of passive electrical components

(76) Inventors: James John Howarth, Albuquerque, NM (US); Chuck Edwards, Rio Rancho, NM (US); Karel Vanheusden, Placitas, NM (US)

Correspondence Address: Jaimes Sher, Esq.;Cabot Corporation, 5401 Venice Avenue NE, Albuquerque, NM, 87113, US

(21) Appl. No.: 11/331,186

(22) Filed: Jan. 13, 2006

Related U.S. Application Data
(60) Provisional application No. 60/695,413, filed on Jul. 1, 2005.
(60) Provisional application No. 60/643,629, filed on Jan. 14, 2005.
(60) Provisional application No. 60/643,577, filed on Jan. 14, 2005.
(60) Provisional application No. 60/643,578, filed on Jan. 14, 2005.

(51) Int. Cl. B41J 2/01

(52) U.S. Cl. 347/102

(57) ABSTRACT

A process of fabricating a passive electrical component, such as a resistor, a capacitor, or an inductor, is provided. The process includes the step of ink-jet printing at least one electronic ink onto a substrate in a predetermined pattern. The step of ink-jet printing may include the steps of: a) selecting at least one electronic ink having at least one electrical characteristic when cured; b) determining a positional layout for a plurality of droplets of the at least one electronic ink such that, when the at least one electronic ink has been cured, the positional layout provides a desired response for the electrical component; c) printing each of the plurality of droplets of the at least one electronic ink onto the substrate according to the positional layout using an ink-jet printing process; and d) curing the at least one electronic ink.

### CROSS-REFERENCE TO RELATED APPLICATIONS

This application claims priority to U.S. Provisional Patent Application Ser. Nos. 60/643,577; 60/643,378; and 60/643,629, all filed on Jan. 14, 2005, the entireties of which are incorporated herein by reference. This application also claims priority to U.S. Provisional Patent Application Ser. No. 60/695,413, filed on Jul. 1, 2005, the entirety of which is incorporated herein by reference.

### BACKGROUND OF THE INVENTION

1. Field of the Invention

The present invention relates to passive electrical components. More particularly, the invention relates to a method and apparatus for printing electrical components onto a substrate using electronic inks that, when cured, have electrical functionalities.

2. Related Art

The electronics, display and energy industries rely on the formation of coatings and patterns of conductive materials to form circuits on organic and inorganic substrates. The primary methods for generating these patterns are screen printing for features larger than about 100 μm and thin film and etching methods for features smaller than about 100 μm. Other subtractive methods to attain fine feature sizes include the use of photo-patternable pastes and laser trimming.

One consideration with respect to patterning of conductors is cost. Non-vacuum, additive methods generally entail lower costs than vacuum and subtractive approaches. Some of these printing approaches utilize high viscosity flowable liquids. Screen-printing, for example, uses flowable mediums with viscosities of thousands of centipoise. At the other extreme, low viscosity compositions can be deposited by methods such as ink-jet printing. However, low viscosity compositions are not as well developed as the high viscosity compositions.

Ink-jet printing of conductors has been explored, but the approaches to date have been inadequate for producing well-defined features with good electrical properties, particularly at relatively low temperatures.

There exists a need for compositions for the fabrication of electrical conductors for use in electronics, displays, and other applications. Further, there is a need for compositions that have low processing temperatures to allow deposition onto organic substrates and subsequent thermal treatment. It would also be advantageous if the compositions could be deposited with a fine feature size, such as not greater than about 100 μm, while still providing electronic features with adequate electrical and mechanical properties.

An advantageous metallic ink and its associated deposition technique for the fabrication of electrically electrical conductors would combine a number of attributes. The electrical conductor would have high conductivity, preferably close to that of the pure bulk metal. The processing temperature would be low enough to allow formation of conductors on a variety of organic substrates (polymers). The deposition technique would allow deposition onto surfaces that are non-planar (e.g., not flat). The conductor would also have good adhesion to the substrate. The composition would desirably be inkjet printable, allowing the introduction of cost-effective material deposition for production of devices such as flat panel displays (PDP, AMLCD, OLED). The composition would desirably also be flexo, gravure, or offset printable, again enabling lower cost and higher yield production processes as compared to screen printing.

Further, there is a need for electronic circuit elements, particularly electrical conductors, and complete electronic circuits fabricated on inexpensive, thin and/or flexible substrates, such as paper, using high volume printing techniques such as reel-to-reel printing. Recent developments in organic thin film transistor (TFT) technology and organic light emitting device (OLED) technology have accelerated the need for complimentary circuit elements that can be written directly onto low cost substrates. Such elements include conductive interconnects, electrodes, conductive contacts and via fills.

Existing printed circuit board technologies use process steps and rigidly define the printed circuit board in the context of layers. Only one layer of conductive material is permitted per layer due to the copper etch process used. In general, devices cannot be mounted on internal layers.

### SUMMARY OF INVENTION

In one aspect, the invention provides a process of fabricating a passive electrical component. The process includes the step of ink-jet printing at least one electronic ink onto a substrate in a predetermined pattern. The step of ink-jet printing may include the steps of: a) selecting at least one electronic ink having at least one electrical characteristic when cured; b) determining a positional layout for a plurality of droplets of the at least one electronic ink such that, when the at least one electronic ink has been cured, the positional layout provides a desired response for the electrical component; c) printing each of the plurality of droplets of the at least one electronic ink onto the substrate according to the positional layout using an ink-jet printing process; and d) curing the at least one electronic ink. The positional layout may be three-dimensional. The step of determining a positional layout may further include providing a unique set of three coordinates to each droplet of the at least one electronic ink, wherein a first coordinate and a second coordinate jointly specify a unique position on the substrate and a third coordinate specifies a cured ink layer, wherein when two droplets have matching first and second coordinates, the droplet having a greater third coordinate is positioned directly above the droplet having a lesser third coordinate.

The electrical component may be a resistor. The step of selecting at least one electronic ink may include selecting at least one electronic ink having a known resistivity when cured. The step of determining a positional layout may include the steps of: i) selecting a portion of the substrate for placement of the resistor; ii) determining a length of the resistor; iii) determining a cross-sectional area of the resistor; iv) determining a shape of the resistor based on the determined length and the determined cross-sectional area and the selected portion of the substrate; and v) determining a position for each droplet of the at least one electronic ink based on results of steps i, ii, iii, and iv. The step of selecting at least one electronic ink may further include selecting exactly one electronic ink having a known resistivity when cured. Alternatively, the step of selecting at least one electronic ink may further include selecting exactly two electronic inks each having a known resistivity when cured, wherein the known resistivity of a first selected cured electronic ink is greater than the known resistivity of a second selected cured electronic ink by at least one order of magnitude, and wherein the step of determining a positional layout further comprises the steps of blending the two electronic inks into a single blended ink in respective predetermined proportions; and determining a resistivity of the blended ink when cured.

The electrical component may be a capacitor. The step of selecting at least one electronic ink may include selecting a first electronic ink having a known dielectric constant when cured and at least a second electronic ink having a known first conductivity when cured. The step of determining a positional layout may include the steps of: i) selecting a portion of the substrate for placement of the capacitor; ii) determining a physical architecture of the capacitor based on the known dielectric constant, the known first conductivity, and the selected portion of the substrate; and iii) determining a position for each droplet of the at least first and second electronic inks based on results of steps i and ii. The step of selecting at least one electronic ink may further include selecting a third electronic ink having a known second conductivity when cured, wherein the known second conductivity is less than the known first conductivity. The step of determining a physical architecture may further include determining a physical architecture of the capacitor based on the known dielectric constant, the known first and second conductivities, and the selected portion of the substrate. The step of determining a position for each droplet may further include determining a position for each droplet of the at least first, second, and third electronic inks based on results of steps i and ii.

The electrical component may be an inductor. The step of selecting at least one electronic ink may include selecting a first electronic ink having a known permeability when cured and a second electronic ink having a known conductivity when cured. The step of determining a positional layout may include the steps of: i) selecting a portion of the substrate for placement of the inductor; ii) determining a physical architecture of the inductor based on the known permeability, the known conductivity, and the selected portion of the substrate; and iii) determining a position for each droplet of the first and second electronic inks based on results of steps i and ii.

In another aspect, the invention provides a printed circuit comprising a substrate and a plurality of electrical components. At least one of the plurality of electrical components is physically mounted onto the substrate. At least one of the plurality of electrical components includes at least one electronic ink that is printed onto the substrate in a predetermined pattern using an ink-jet printing process. At least one of the plurality of electronic components may include at least two electronic inks that are printed onto the substrate in a predetermined pattern using an ink-jet printing process. The at least two electronic inks may be blended together prior to being cured. Alternatively, one of the at least two electronic inks may be cured prior to the other electronic ink being printed onto the substrate. The at least one electrical component that is printed onto the substrate using an ink-jet printing process may be selected from the group consisting of a conductor; a resistor; a capacitor; an inductor; a transistor; a dielectric; an insulator; a sensor; a diode; a keyboard; an input device; a relay; a switch; and a pixel. The at least one electrical component that is physically mounted onto the substrate may be selected from the group consisting of an integrated circuit, a high-precision resistor, a high-precision capacitor, an inductor, a transistor, an oscillator, a crystal, a connector, a sensor, an LED, a ferrite, a switch, a filter, a jumper, and a battery.

In yet another aspect of the invention, a process of constructing an electrical circuit is provided. The electrical circuit includes a plurality of electrical components. The process includes the steps of: a) fabricating at least one of the plurality of electrical components using at least one electronic ink by ink-jet printing the at least one electronic ink onto a substrate in a predetermined pattern; and b) physically mounting at least one of the plurality of electronic components onto the substrate. The fabricating step may include the steps of: i) selecting at least one electronic ink having at least one electrical characteristic when cured; ii) determining a positional layout for a plurality of droplets of the at least one electronic ink such that, when the at least one electronic ink has been cured, the positional layout provides a desired response for the electrical component; iii) printing each of the plurality of droplets of the at least one electronic ink onto the substrate according to the positional layout using an ink-jet printing process; and iv) curing the at least one electronic ink. The at least one electrical component that is fabricated using at least one electronic ink may be selected from the group consisting of a conductor; a resistor; a capacitor; an inductor; a transistor; a dielectric insulator; a sensor; a diode; a keyboard; an input device; a relay; a switch; and a pixel. The at least one electrical component that is physically mounted onto the substrate may be selected from the group consisting of an integrated circuit, a high-precision resistor, and a high-precision capacitor, an inductor, a transistor, an oscillator, a crystal, a connector, a sensor, an LED, a ferrite, a switch, a filter, a jumper, and a battery.

### BRIEF DESCRIPTION OF THE DRAWINGS

FIG. 1 is an illustration of an electrical component that is surface mounted onto a substrate.

FIG. 2 is an illustration of a resistor and a capacitor that are deposited onto a substrate using an ink-jet process, according to a preferred embodiment of the invention.

FIGS. 3a-3e are illustrations of potential defects that may occur in forming a resistor using an ink-jet process.

FIGS. 4a-4c are illustrations of exemplary resistor layouts that may be produced using an ink-jet process according to a preferred embodiment of the invention.

FIGS. 5a-5c are illustrations of exemplary inductor layouts that may be produced using an ink-jet process according to a preferred embodiment of the invention.

FIGS. 6a and 6b are illustrations of an inkjet printing technique using depositions of separated lines of inks.

FIGS. 7a and 7b are illustrations of surface smoothness of components produced using ink-jet printing techniques according to an embodiment of the invention.

FIGS. 8a-8e are illustrations of exemplary dot patterns that may be produced using an ink-jet process according to an embodiment of the invention.

FIGS. 9a and 9b are illustrations of exemplary resistor layouts that may be produced using an ink-jet printing process according to an embodiment of the invention.

FIG. 10 is an illustration of an exemplary resistor layout that may be produced using an ink-jet process according to a preferred embodiment of the invention.

FIG. 11 is an illustration of surface roughness and surface variations on a substrate used for deposition of electronic inks according to an embodiment of the invention.

FIG. 12 is an illustration of a resistive via construct according to a preferred embodiment of the invention.

FIGS. 13a and 13b are illustrations of layout techniques for a capacitor using an ink-jet process according to a preferred embodiment of the invention.

### DETAILED DESCRIPTION OF THE INVENTION

Ink jet deposition of different materials allows for replacement of standard Surface Mount (SMT) components that can be fabricated on the fly during the manufacturing process. Passive component fabrication via ink jet printing has an advantage over SMT technology in that components having a wide range of values can be deposited at any given time. In this manner, ink jet printing of components provides a direct advantage with respect to SMT technology, for which only discrete component values exist.

A second advantage provided by the fabrication of ink jet printable passive components according to the present invention, with respect to SMT discrete components, is the elimination of the need to stock SMT components. Conventional PCB manufacturers are typically required to stock vast quantities of different SMT components in order to keep the manufacturing line operating. If any one component becomes unavailable, the manufacturing line may be required to shut down until a new stock of SMT components becomes available. Ink jet printing of passive components eliminates the risk of running out of SMT components and allows manufacturers to simplify their procurement processes by merely stocking several different electrical component inks to fabricate a wide variety of components as the demand arises.

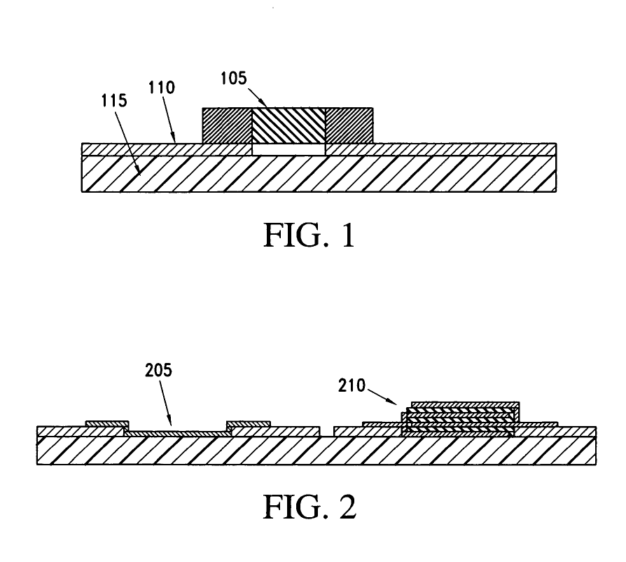

Referring to FIG. 1, a typical prior art surface mount component 105 is shown. In a conventional surface mount process, solder is screen printed onto a printed circuit board. Then, pick-and-place robotic equipment is used to place the SMT component 105 on the substrate pads 110. Finally, the FR4 substrate 115 with the placed SMT component 105 is put through an IR reflow process to melt the solder and attach the SMT component 105 to the substrate 115.

Referring to FIG. 2, ink jet printing of resistors, capacitors and inductors according to a preferred embodiment of the present invention allows for the fabrication of the devices in many different shapes, resulting in devices having different characteristics which depend on the implementation. For example, resistor 205 and capacitor 210 are fabricated by an ink jet printing process onto substrate 215. Additional advantages provided by ink jet printing of passive components versus conventional production of equivalent SMT components include: reduction of manufacturing steps, eliminating the need for solder paste screening, and elimination of pick-and-place processes.

Each of the passive components can be made using at least one out of five types of electronic inks: a conductive ink; a resistive ink; a dielectric ink; a ferrite ink; and an insulative ink. Insulative ink may also be used as a base support material for the ink jet materials printed on top of it in subsequent layers. For this reason, the insulative ink should be selected such that its adhesion strength and its coefficient of thermal expansion provide stability and compatibility with the other inks to be used in the circuit.

A library that includes each of the electronic inks to be used for the circuit is constructed. The library interacts with computer-aided engineering (CAE) software that includes programs that are designed to select available component types based on the electronic inks available, the specified layer, and the sequence of inks. Alternatively, the CAE software could be provided a designed electrical circuit as an input, and then the software would specify the sequence of inks and layers based on the designed circuit.

It is noted that the same ink may be printed several times in different layers. For example, there may be several interconnect layers, or several layers of embedded passive components. In addition, if an ink jet printing system having multiple print heads is being used for deposition of the electronic inks, it is possible to print multiple electronic inks in a single pass (i.e., a single layer). For optimal system performance, the CAE software will be programmed in accordance with these system capabilities.

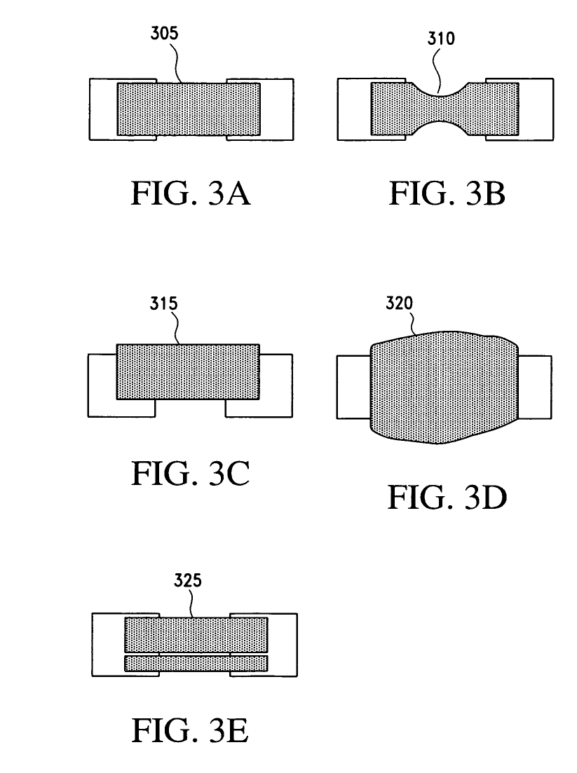

Referring to FIGS. 3a-3e, several issues arise in the general deposition of ink jet passive components that electronic component inks and print systems must overcome. These defects may result from improper substrate/ink interaction as well as misalignment due to printing device limitations. Five different examples of ink jet component fabrication of resistors are illustrated. FIG. 3a shows a properly aligned component 305. FIG. 3b shows a resistor 310 that experienced ink narrowing of the material. FIG. 3c shows a resistor 315 which was misaligned due to improper alignment of the substrate and print head mechanism. FIG. 3d shows a resistor 320 where ink spread into unintended locations. FIG. 3e shows a resistor 325 where the print system lost material deposition capability through one pixel line of the intended component. The missing pixel line phenomenon of FIG. 3e may also be extended to a plurality of pixels, or pixel lines. In general, the total resistance of a resistor is a sum of three series resistances: The nominal resistance of the printed resistor plus the resistances of the two resistor-pad connections at both ends of the printed resistor. Ideally, the resistance of each of the resistor-pad connections is approximately zero; however, these resistances are a function of the thickness of the ink layers at each end and the tolerance, or overlap, between the printed resistor and the pad.

Ink Jet Printing of Resistors

For most printed circuit boards, the resistance of most resistors falls into the range of 1-500 k ohms. Thus, the range of likely resistance values covers six orders of magnitude. A single resistive ink 135 could be used to make all of these resistors, but this would require very large and long resistor layouts to print the high-ohm resistors. A preferred method for fabricating resistors is to print multiple resistive inks. For example, a three-ink system may be optimal; however, any number of resistive inks may be used. In general, for each additional electronic ink used, there are additional processing costs, due to the need for additional printing stations, additional ink jet printing heads, and added complexity to the circuit layout. Therefore, in an exemplary embodiment, a three-ink system for making resistors includes a first resistive ink having a low resistance of less than 500 ohms per square of printed ink (e.g., 5 ohms per square), a second resistive ink having a medium resistance of between 500 and 10,000 ohms per square of printed ink (e.g., 1000 ohms per square), and a third resistive ink having a high resistance of greater than 10,000 ohms per square of printed ink (e.g., 100,000 ohms per square).

Multiple methods for printing resistors may be used according to the present invention. In a first method, a single ink can be used for an individual resistor. With this method, it is possible to print the entire resistor in one pass of the ink jet printer. However, the length and cross-sectional area of the resistor may need to be longer or larger when using this method, in order to achieve the target resistance value.

In a second method, a plurality of inks may be used in a “wet on dry” or a “wet on cured material”, multi-pass technique. To execute this method, a pattern of two or more inks is determined based on the respective resistivities of the inks and the target resistance value. After each pass of the ink-jet printer, it is required to dry or cure at full temperature the deposited ink layer prior to deposition of the next layer of ink. In this manner, a “wet” layer of ink is deposited on top of a “dry” or fully temperature cured layer of ink.

A third method involves wet-on-wet deposition of two or more electronic inks. Wet-on-wet deposition may involve blending of the inks. In this method, a plurality of inks are selected such that when blended in a predetermined proportion, the resistivity of the blended ink is optimized, based on the target resistance value and a desired dimensional layout of the ink upon the substrate. For this method, the inks may be deposited in a single pass, with a wet ink being printed on top of another wet ink that was deposited moments earlier. This may be achieved in an ink jet printing system having multiple print heads by loading the different inks into different print heads. Alternatively, wet-on-wet deposition may involve two inks that do not blend together. For example, one ink may be a water-based ink, and the other ink may be an oil-based ink. As another example, one ink may be a hydrophilic ink and the other may be a hydrophobic ink. When non-blending inks are used, the effect is similar to that of wet-on-dry deposition, because although the first ink is not cured prior to deposition of the second ink, the two inks eventually cure without blending together, thus resulting in two separate layers of ink.

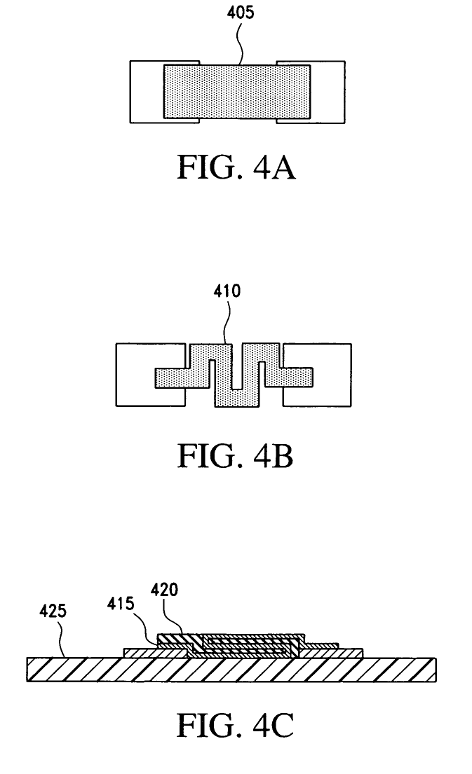

Referring to FIGS. 4a-4c, there are many different types of layouts that can be used to fabricate embedded ink jet resistors. Exemplary resistor layouts include a planar resistor 405, which comprises a rectangular layout of a resistive ink or combination of inks; and a serpentine resistor 410, which comprises an elongated, piecewise rectangular layout of resistive ink(s). The thickness of the deposited ink may also be varied in order to produce a desired resistance and/or tolerance.

Referring to FIG. 4c, a vertical serpentine resistor 415 is shown. The resistor 415 is also an elongated, piecewise rectangular layout of resistive inks, but which also uses layers of conductive or dielectric ink 420 deposited within the layout. As in the example of a vertical serpentine resistor 415, in some instances it may be beneficial to fabricate a resistor that traverses in the direction perpendicular to the substrate 425. Ink jet deposition material allows for resistor devices to be produced in three dimensions, often saving printed circuit board real estate.

The general equation for determining the resistance of a structure is shown in Equation 1 below:
Resistance=ρL/A, Equation 1
where ρ=Resistivity of Material in Ω-cm; L=length of device in cm; and
A=cross sectional area in cm².

An ink jet resistor is fabricated using the following process steps:

1) Highly conductive material is deposited onto a substrate, or in some instances, is patterned using various different patterning techniques to form contacts for the resistor material. These resistor contacts or pads may also be fabricated using ink jet deposition techniques. The contacts or pads are dimensioned such that alignment tolerances of the printing device are met or exceeded. The pads are spaced in a manner to achieve the desired resistance value that can be described by the above equation. Typically, the substrate may be in the form of a conventional printed circuit board. Alternatively, a non-rigid substrate may be used; examples of non-rigid substrates include polyimide; polycarbonate; PET; PEN, and paper or cardstock.

2) Next, the resistive material is deposited via ink jet device, connecting the contacts or pads together with the resistive material. Ideally, the resistor is perfectly aligned between the pads, and sufficient resistive material is deposited over each contact/pad as to minimize the contact resistance. The described steps in the creation of an ink jet resistor can be interchanged. For example, in applications where the contacts/pads may also be deposited (i.e., the contacts/pads are not constrained to being on the substrate before the resistive material is deposited), the contacts/pads may be deposited over the resistive material to form the device. Fabrication of ink jet resistors in this method may be extended to serpentine and vertical serpentine formats.

3) A cure step, either in between deposition of each dissimilar material, or after deposition of both dissimilar materials may occur using either an infrared cure technique, oven cure, hot air, ultraviolet curing, microwave energy, or inductive heating.

4) In some applications, build up of material consisting of a multitude of ink deposition steps may require a dry or cure step between each material deposition step for proper device fabrication. This dry step may occur using any of the previously mentioned cure techniques and may occur at a multitude of temperatures.

5) A plurality of printing patterns, such as, for example, individually separated pixels, individual separated lines including but not limited to vertical lines, horizontal lines, and diagonal lines, a cross hatch pattern, a checkerboard, or array of dots, may be used to build up layers of either the highly conductive contact pads or the resistor material.

6) In some instances, the resistive as well as conductive materials may require encapsulation to ensure proper operation over the lifetime of the device.

7) In some instances, material build-up may be performed by wet-on-wet printing of inks multiple times before performing a cure step. This technique allows for build-up of material that may be required at specified locations within a circuit.

Ink Jet Printing of Capacitors

Dielectric inks are used to print internal, non-conductive layers in passive components such as capacitors. When cured, these inks have varying dielectric constants and interfaces which make them behave uniquely in different devices. It is therefore possible that multiple dielectric inks may be needed. Dielectrics, by nature, are insulative, as opposed to conductive; therefore, in some printing systems, if a minimal number of layers or inks is desired, a dielectric ink may be used as both the dielectric layer and the insulative layer. In other cases, where two separate inks can be used, it is likely that passive components will use a very thin layer of a dielectric ink having a relatively high dielectric constant (i.e., a high-K dielectric ink having a dielectric constant greater than 50.0) with low loss, and that a low-K dielectric ink having a dielectric constant less than 50.0 printed in thicker, protective layers will be used for insulation functions.

The general equation for determining the capacitance of a structure is shown in Equation 2 below:
C=(ε₀kNA)/t, Equation 2
where ε₀=the permittivity of free space=8.854×10⁻¹² F/m; k=the relative dielectric constant and is dependent on the material used as the dielectric;
N=the number of active layers of the capacitor; A=the cross sectional area of the capacitor; and T=the distance between the electrodes of the capacitor.

An ink jet capacitor is fabricated using the following process steps:

1) Capacitor electrodes may be formed using one or more conducting inks deposited onto a substrate. Use of multiple inks as part of the electrodes may be used, as some materials have a tendency to diffuse together. More specifically, a first electronic ink may be used as a highly conductive electrode, and a second electronic ink may be used as a barrier material between the highly conductive layer and dielectric layer. In a preferred embodiment, only one conductor ink is used as the electrode of a capacitor. In some applications, an electrode or electrodes may already exist on the substrate, thus avoiding the need to be printed separately. Typically, the substrate may be in the form of a conventional printed circuit board. Alternatively, a non-rigid substrate may be used; examples of non-rigid substrates include polyimide; polycarbonate; PET; PEN, and paper or cardstock.

2) In another printing step, a first dielectric layer is printed on top of the first electrode, followed by the printing of a second electrode on top of the first dielectric layer. In some applications, these layers may be built up without the need for a cure step in between each printing. In other applications, a cure step is performed after printing of each layer. Different dielectric inks may be used between the electrodes of the capacitor to allow for different ranges of capacitor values, or to meet a variety of performance targets for the device, such as dielectric loss or material cost. The thickness of the dielectric layer can also be modified to change the capacitance value or increase the maximum allowable voltage across the electrodes.

3) Multiple layers may be printed in this fashion to increase the capacitance value as shown in Equation 2 above. Ink jet capacitors allow for a simplified method of multiple layer buildup to increase the capacitance value. By contrast, presently available embedded capacitor technology typically allows for only two electrodes with a single dielectric layer of separation.

4) Ink jet capacitors may take on a variety of shapes. More specifically, the electrodes are not limited to simply squares or rectangles, but can be fabricated in any two-dimensional shape, such as a circle, a triangle, etc. The versatility of capacitor shape using ink jet capacitor technology provides a distinct advantage over equivalently valued surface mount capacitors. The shape of a capacitor may be chosen or designed to fit into an area on a printed circuit board where an SMT component would not be able to do so, as a practical matter.

5) A capacitor that is fabricated using ink-jet printing technology is not limited to the conventional stacked parallel plate design. For example, an interdigital capacitor that may or may not include the addition of a dielectric material may also be ink-jet printed. Such an interdigital capacitor is useful in creating capacitors having sub-1 pF values, and thus finds many applications at microwave frequencies.

Ink Jet Printing of Inductors:

Ferrites are unique materials that have electromagnetic qualities. They are used as cores in inductors, and they can also be used to prevent electromagnetic interference (EMI) and for noise suppression. Ferrite inks can also be made to be magnetically programmable, e.g., magnetic ink character recognition (MICR), thus providing value as programmable media. For example, this application can be used as the magnetic stripe on the back of a credit card, or for read/write memory. There are situations in which a single ferrite ink may be used, and there are other situations in which more than one ferrite ink may be used as a blended ink or to provide two ferrite inks having different permeabilities when cured. Typically, ferrite inks use iron, nickel, cobalt, and/or alloys of these metals.

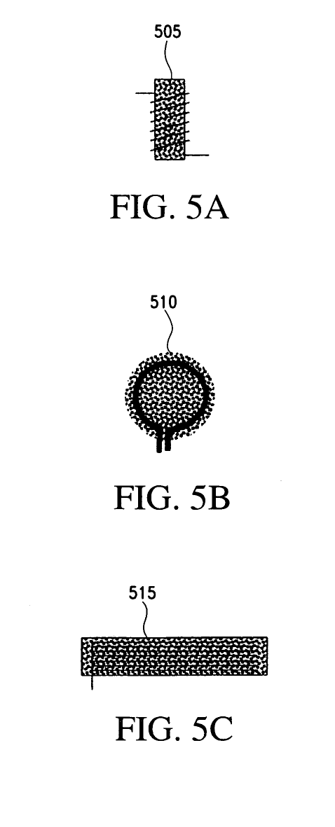

Referring to FIGS. 5a-5c, three exemplary layouts for fabrication of inductors using ink jet printing are shown. Inductor SOS shows a typical inductor having an arbitrary number of coil turns surrounding a magnetic core. Inductor 510 shows a single turn planar inductor. Inductor 515 shows a helical coil surrounded by a magnetic material. The general equation for inductance of a coil of wire is shown in Equation 3 below:
L=μ₀μᵣN²A/l, Equation 3
where μ₀=the permeability of free space; μᵣ=the relative permeability of the core material surrounded by the coil; N=the number of coil turns; A=the cross-sectional area of each turn; and L=length of magnetic circuit.

Ink Jet inductors may be fabricated in the following manner:

1) Inductors are fabricated by combining a conducting ink along with a magnetic ink. Based on the above equation, the value of the inductor is proportional to both the cross-sectional area of the turn (i.e., loop) and the length of the circuit. Thus, the dimensions of the loop area can be adjusted to modify the inductance value.

2) Layer buildup may be performed to add additional turns to an inductor to modify the inductance value of the component. Inductors may take several exemplary forms: a coil of conducting material wrapped around a magnetic core, such as inductor SOS shown in FIG. 5a; a conducting material wrapped around a toroid; a helical coil of a conducting material surrounded by a magnetic material, such as inductor 515 shown in FIG. 5c; and a loop of conducting material wound in such a way that a first loop encompasses a second loop, which may also encompass a third or a plurality of loops lying in the same plane, such as inductor 510 shown in FIG. 5b.

3) These magnetic cores, which may or may not be present in an inductor, are classified as ferromagnetic, ferrimagnetic, paramagnetic (i.e., the relative permeability is slightly greater than 1.0), and superparamagnetic (i.e., magnetic particles are suspended in a non-ferrous matrix).

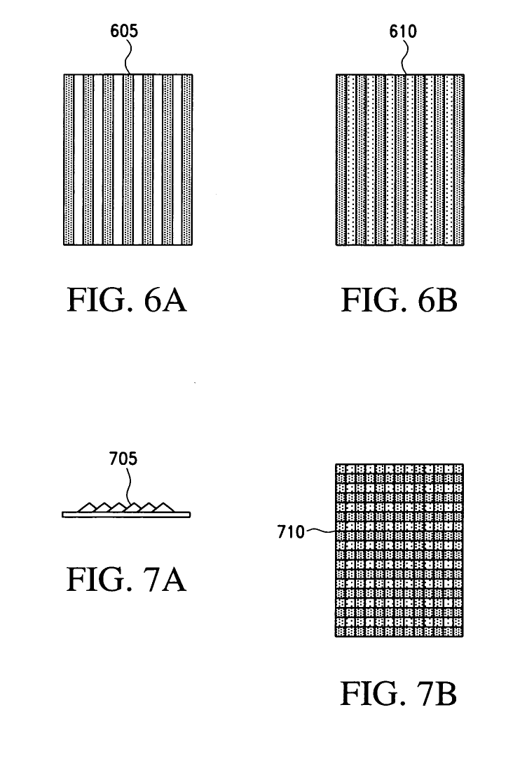

Referring to FIGS. 6a and 6b, inkjet printing of passive components may cause an impact due to edge control and shape of the passive component. In general, a dome shape does not affect ability to predict the values of resistance, so long as the cross-sectional area is constant and predictable. In some instances, the ink material may be modified to allow for steeper or almost vertical edges in a device. In other instances, the outside boundary of a device can be formed first, cured, and additional material may be deposited inside the boundary. Additionally, it may be advantageous to fabricate a device in a “Lincoln Log” manner where the device is fabricated using separated lines of material. The Lincoln Log manner is illustrated in FIGS. 6a and 6b. The first deposition 605 includes several lines of a first ink which are deposited such that the lines are separated from each other, and the second deposition 610 includes several lines of a second ink which are deposited in the spaces between the separated lines deposited as shown in deposition 605. In addition, empirical data may be used to improve accuracy, especially in relation to a shape of a device or substrate characteristics.

Referring to FIGS. 7a and 7b, deposition of materials via ink jet device may sometimes result in a device that does not have a preferred level of surface smoothness. An example of such a device 705 is shown in FIG. 7a. Printing an orthogonal set of traces 710, as illustrated in FIG. 7b, may help to smooth the surface layer of multilayer devices, such as in resistors, capacitors, or inductors. The material may itself in some instances be used as a smoothing or planarization layer.

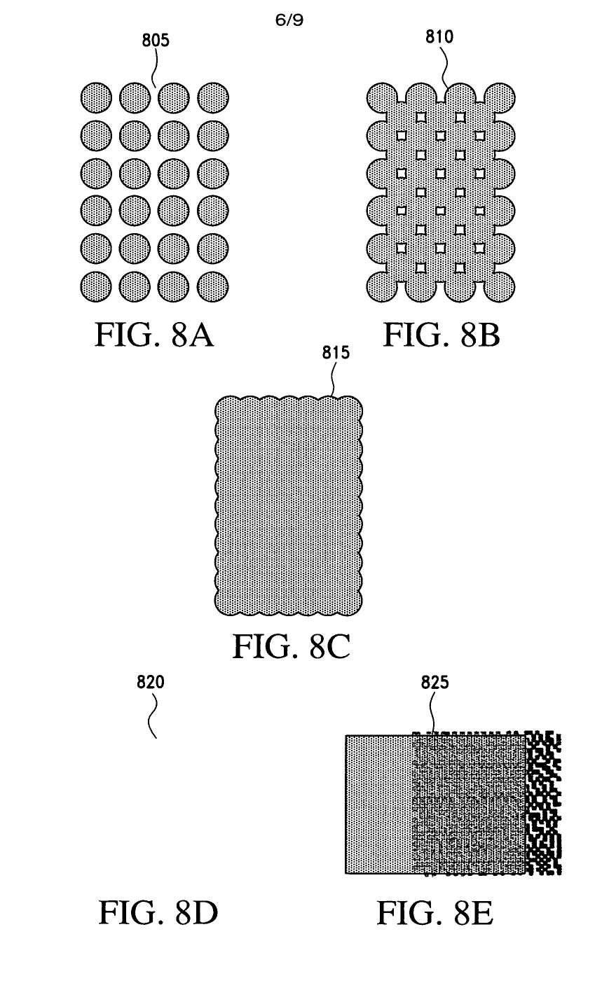

Referring to FIGS. 8a-8e, in some instances, the print head system can be used to allow all nozzles in the print head to contribute to a random pattern in fabrication of the passive component. This process is beneficial since variations exist in the performance of the print head that would result in components that exceed the tolerance requirement if all nozzles were not used to contribute to the component. Special dot patterns can be used to accomplish this task of utilizing all print nozzles to construct an electronic component. Variations in the deposition of materials are especially critical in the fabrication of resistors, but may also apply to the fabrication of capacitors, and inductors.

To overcome these variations, different print mechanisms may be employed that minimize the effect of one or more nozzles operating incorrectly during the ink deposition process. Referring to FIGS. 8a, 8b, and 8c, as an example, a 24-nozzle ink jet head could print the dot pattern 915, for which each nozzle is programmed to deposit a drop, versus other applications for which a nozzle may be programmed to deposit a line of drops. In this example, on a first pass, the pattern 805 is deposited; then, on a second pass, additional drops are deposited to produce the pattern 810; and then on a third pass, the dot pattern 815 is produced. For this example, because each nozzle deposits only one drop per pass, if a nozzle is not functioning, then only a single drop will be missing on each pass, instead of a whole row of ink drops being missing, as would be the case if the nozzles were programmed to deposit a line of drops on each pass. A whole line of missing drops would contribute to a higher error in the amount of deposited material versus a single missing drop. This methodology can be used to form a near rectangular device that could be used as a resistor, electrode of a capacitor, dielectric material of a capacitor, a conductor, or a magnetic core of an inductor. Referring to FIGS. 8d and 8e, the dot pattern itself may be randomized, as shown in the pattern 820. By randomizing the dot pattern itself, potential problems relating to slight misregistration of the print heads or nozzles may be avoided, because the randomization causes a deliberate lack of symmetry in the deposition pattern, and thus, through repeated deposition of layers, such errors tend to be overcome, as shown in pattern 825, rather than duplicated, as they would be in a symmetrical dot pattern.

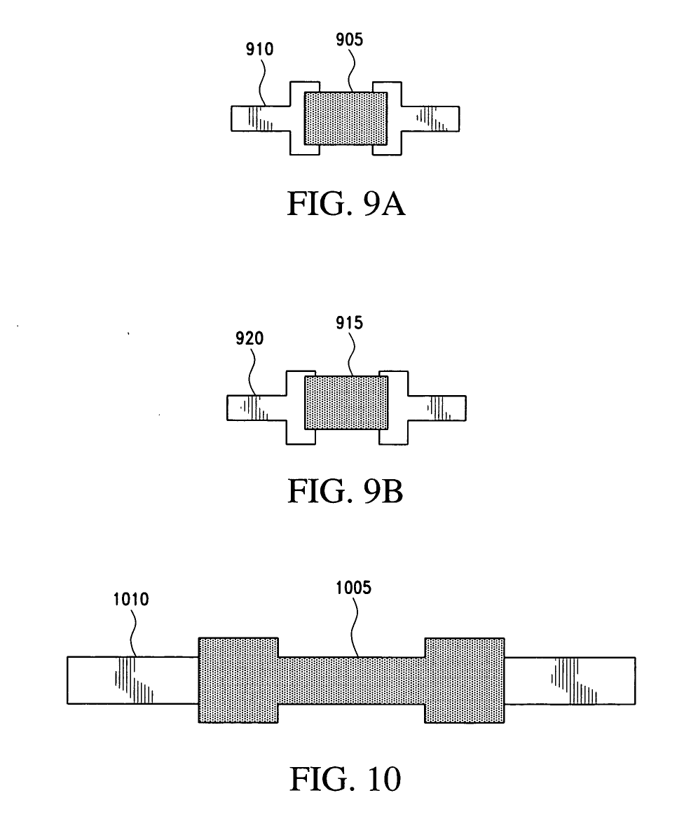

Referring to FIGS. 9a and 9b, the conductor traces of the terminals of an ink jet printed resistor may be made larger than the resistor dimensions to allow for tolerances in the deposition of the resistive electronic ink. In FIG. 9a, resistor 905 is correctly aligned onto resistor pads 910, which have been made larger than the resistor width. In FIG. 9b, resistor 915 is slightly misregistered with respect to resistor pads 920, but because the pads 920 are larger than the resistor width, there is no reduction of performance in the resistor. Referring to FIG. 10, an alternative approach is to make the resistor material 1005 larger than the pads 1010. Again, such an approach may be beneficial to ensure connectivity between pads even when a slight misalignment occurs.

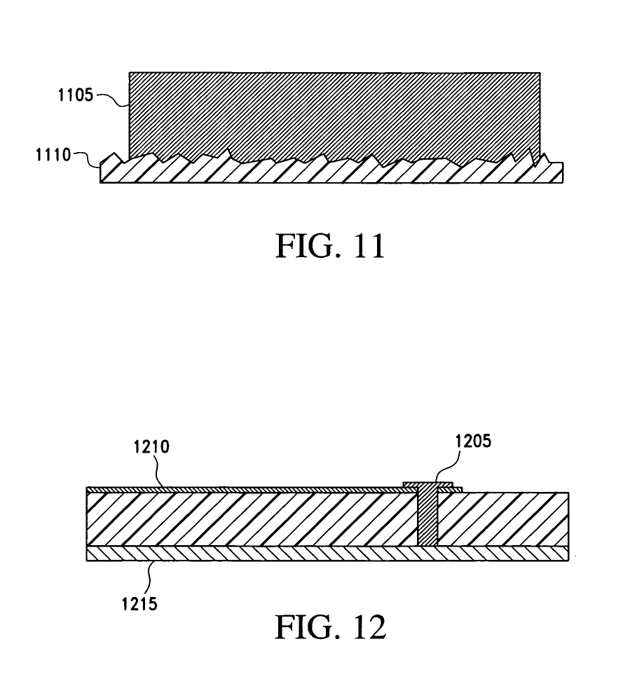

Referring to FIG. 11, layer thickness in resistors may help to alleviate variations that may be present on the substrate. For example, building a layer 1105 of the component that is substantially higher than the average surface roughness of the substrate 1110 may alleviate variations in resistance value in final component fabrication. In some manufacturing processes, surface roughness may need to be evaluated and the value bound to some known minimum and maximum levels in order to reliably fabricate resistors, capacitors, and inductors using ink-jet printing.

Referring to FIG. 12, ink jet printing of resistive materials also enables resistive via constructs that can be used for pull-up or pull-down of digital lines. In many applications in modern digital technology, it is advantageous to connect signal traces through a resistor to a voltage or ground plane in a printed circuit board. Typically, the only usable resistive components have been conventional surface mount resistors. However, according to a preferred embodiment of the present invention, ink jet resistor technology allows for inexpensive printing of resistive vias, such as via 1205, which serves the function of connecting a signal trace 1210 to either a voltage or ground plane 1215. Often, drive circuits existing on signals networks only have the ability to drive a signal to only a voltage level or ground, but not both. Typically, in applications where resistors serve to tie an undriven line to either a voltage level or ground, the tolerance level of the resistance value is not the critical design issue. For example, the value of the resistor may be able to vary up to 50%. In this case, a resistive via construct 1205 allows for low cost and reduced printed circuit card real estate requirement.

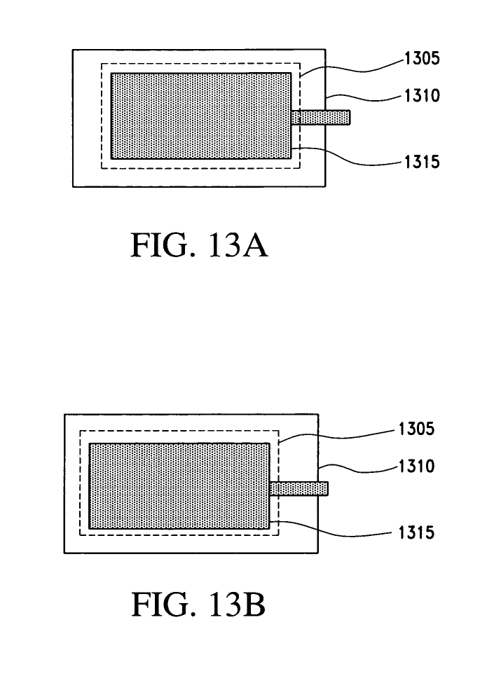

Referring to FIGS. 13a and 13b, for capacitor fabrication, printing of the electrode layers and dielectric layers can be performed in such a way as to minimize the effect of print device registration concerns. FIG. 13a shows an example of this layout technique: The first layer 1305 is an oversized electrode layer; the second layer 1310, printed on top of first layer 1305, is an oversized dielectric layer; and the third layer 1315, printed on top of second layer 1310, is an undersized electrode layer. This technique, when implemented in such a way as to take into account the maximum level of ink jet print device misregistration, may have the ability to fabricate capacitors that have predictable values independent of misregistration. An example of a capacitor exhibiting such misregistration is shown in FIG. 13b. Since the electrodes 1305 and 1315 completely overlap, and since the dielectric layer 1310 completely separates the electrodes 1305 and 1315, the slightly misregistered capacitor should exhibit very nearly the same value and very nearly the same performance as a perfectly aligned capacitor.

At least two types of repair applications may be performed using an ink-jet printing system according to an embodiment of the present invention. Using optical recognition, flaws in the circuit manufacture may be found. Such flaws may include mouse bites, short circuits, open circuits, or incorrect resistance values. Such flaws may be corrected through selective ink-jet printing over the flawed portions of the circuit. Another type of repair application is to repair flaws in the circuit design. “Cuts” and “jumpers” may be ink-jet printed directly onto finished circuit boards. Because ink-jet printing is non-contact and may be performed at a distance from the substrate, it is possible to print onto finished printed circuit boards despite the presence of components and solder bumps, which would generally create major obstacles for other printing technologies. This capability also enables last-minute engineering changes that may be printed directly onto a printed circuit board as an alternative to manually soldering a wire to perform the same function.

Another possible application, according to an embodiment of the present invention, is to merge conventional surface mounting of components onto the substrate with ink-jet printing onto the substrate. Both sides of the substrate may be used. In order to have two sided component placement, it is necessary to have contacts established on the back side of the printed board. This can be accomplished with traditional drilled via holes through the substrate. Then, the board can be flipped and printed on the back side. The interconnect material in the vias can be provided through hole plating, either conventionally or using ink-jet printing. After the base board has been completed, multi-layer printing of the circuits may be done on both sides of the substrate. This may be desirable for greater circuit complexity or for greater structural integrity. For simpler circuits, it may be desirable to have all of the printing and components on one side of the printed board.

In another embodiment, integrated circuit dies and traditional components may be mounted on the substrate prior to printing. Using an alignment system, the interconnections can be printed directly onto the pads of these devices. In this embodiment, the pads must be on the top sides of the components, i.e., exposed to the printing, and it is desirable to use a tapered ramp or transition material to reduce the vertical transition for the printed electronic ink. For example, solder replacement ink may be deposited using an ink-jet printing process, in lieu of using actual solder to connect a surface mount component to the substrate.

Alternatively, the board can be printed first, and then surface mounting of integrated circuit dies and traditional components can be performed. In this embodiment, soldering or a conductive adhesive will generally be used. It is possible for the ink-jet printer to deposit the solder or conductive adhesive in preparation for component insertion.

While the present invention has been described with respect to what is presently considered to be the preferred embodiment, it is to be understood that the invention is not limited to the disclosed embodiments. To the contrary, the invention is intended to cover various modifications and equivalent arrangements included within the spirit and scope of the appended claims. The scope of the following claims is to be accorded the broadest interpretation so as to encompass all such modifications and equivalent structures and functions.

What is claimed is:

1. A process of fabricating a passive electrical component, comprising the step of ink-jet printing at least one electronic ink onto a substrate in a predetermined pattern.

2. The process of claim 1, wherein the step of ink-jet printing includes the steps of:
a) selecting at least one electronic ink having at least one electrical characteristic when cured;
b) determining a positional layout for a plurality of droplets of the at least one electronic ink such that, when the at least one electronic ink has been cured, the positional layout provides a desired response for the electrical component;
c) printing each of the plurality of droplets of the at least one electronic ink onto the substrate according to the positional layout using an ink-jet printing process; and
d) curing the at least one electronic ink.

3. The process of claim 2, the positional layout being three-dimensional, and the step of determining a positional layout further comprising providing a unique set of three coordinates to each droplet of the at least one electronic ink, wherein a first coordinate and a second coordinate jointly specify a unique position on the substrate and a third coordinate specifies a cured ink layer, wherein when two droplets have matching first and second coordinates, the droplet having a greater third coordinate is positioned directly above the droplet having a lesser third coordinate.

4. The process of claim 2, wherein the electrical component comprises a resistor.

5. The process of claim 4, wherein the step of selecting at least one electronic ink comprises selecting at least one electronic ink having a known resistivity when cured, and wherein the step of determining a positional layout comprises the steps of:
i) selecting a portion of the substrate for placement of the resistor;
ii) determining a length of the resistor;
iii) determining a cross-sectional area of the resistor;
iv) determining a shape of the resistor based on the determined length and the determined cross-sectional area and the selected portion of the substrate; and
v) determining a position for each droplet of the at least one electronic ink based on results of steps i, ii, iii, and iv.

6. The process of claim 5, wherein the step of selecting at least one electronic ink further comprises selecting exactly one electronic ink having a known resistivity when cured.

7. The process of claim 5, the step of selecting at least one electronic ink further comprising selecting exactly two electronic inks each having a known resistivity when cured,
wherein the known resistivity of a first selected cured electronic ink is greater than the known resistivity of a second selected cured electronic ink by at least one order of magnitude, and
wherein the step of determining a positional layout further comprises the steps of:
blending the two electronic inks into a single blended ink in respective predetermined proportions; and
determining a resistivity of the blended ink when cured.

8. The process of claim 2, wherein the electrical component comprises a capacitor.

9. The process of claim 8, wherein the step of selecting at least one electronic ink comprises selecting a first electronic ink having a known dielectric constant when cured and at least a second electronic ink having a known first conductivity when cured, and wherein the step of determining a positional layout comprises the steps of:
i) selecting a portion of the substrate for placement of the capacitor;
ii) determining a physical architecture of the capacitor based on the known dielectric constant, the known first conductivity, and the selected portion of the substrate; and
iii) determining a position for each droplet of the at least first and second electronic inks based on results of steps i and ii.

10. The process of claim 9, wherein the step of selecting at least one electronic ink further comprises selecting a third electronic ink having a known second conductivity when cured, wherein the known second conductivity is less than the known first conductivity, and
wherein the step of determining a physical architecture further comprises determining a physical architecture of the capacitor based on the known dielectric constant, the known first and second conductivities, and the selected portion of the substrate; and
wherein the step of determining a position for each droplet further comprises determining a position for each droplet of the at least first, second, and third electronic inks based on results of steps i and ii.

11. The process of claim 2, wherein the electrical component comprises an inductor.

12. The process of claim 11, wherein the step of selecting at least one electronic ink comprises selecting a first electronic ink having a known permeability when cured and a second electronic ink having a known conductivity when cured, and wherein the step of determining a positional layout comprises the steps of:
i) selecting a portion of the substrate for placement of the inductor;
ii) determining a physical architecture of the inductor based on the known permeability, the known conductivity, and the selected portion of the substrate; and
iii) determining a position for each droplet of the first and second electronic inks based on results of steps i and ii.

13. A printed circuit comprising a substrate and a plurality of electrical components, wherein at least one of the plurality of electrical components is physically mounted onto the substrate, and wherein at least one of the plurality of electrical components includes at least one electronic ink that is printed onto the substrate in a predetermined pattern using an ink-jet printing process.

14. The printed circuit of claim 13, wherein at least one of the plurality of electronic components includes at least two electronic inks that are printed onto the substrate in a predetermined pattern using an ink-jet printing process.

15. The printed circuit of claim 14, wherein the at least two electronic inks are blended together prior to being cured.

16. The printed circuit of claim 14, wherein one of the at least two electronic inks is cured prior to the other electronic ink being printed onto the substrate.

17. The printed circuit of claim 13, wherein the at least one electrical component that is printed onto the substrate using an ink-jet printing process is selected from the group consisting of a conductor; a resistor; a capacitor; an inductor; a transistor; a dielectric insulator; a sensor; a diode; a keyboard; an input device; a relay; a switch; and a pixel.

18. The printed circuit of claim 13, wherein the at least one electrical component that is physically mounted onto the substrate is selected from the group consisting of an integrated circuit, a high-precision resistor, a high-precision capacitor, an inductor, a transistor, an oscillator, a crystal, a connector, a sensor, an LED, a ferrite, a switch, a filter, a jumper, and a battery.

19. A process of constructing an electrical circuit, the electrical circuit including a plurality of electrical components, and the process comprising the steps of:
a) fabricating at least one of the plurality of electrical components using at least one electronic ink by ink-jet printing the at least one electronic ink onto a substrate in a predetermined pattern; and
b) physically mounting at least one of the plurality of electronic components onto the substrate.

20. The process of claim 19, wherein the fabricating step includes the steps of:
i) selecting at least one electronic ink having at least one electrical characteristic when cured;
ii) determining a positional layout for a plurality of droplets of the at least one electronic ink such that, when the at least one electronic ink has been cured, the positional layout provides a desired response for the electrical component; and
iii) printing each of the plurality of droplets of the at least one electronic ink onto the substrate according to the positional layout using an ink-jet printing process; and
iv) curing the at least one electronic ink.

21. The process of claim 19, wherein the at least one electrical component that is fabricated using at least one electronic ink is selected from the group consisting of a conductor; a resistor; a capacitor; an inductor; a transistor; a dielectric insulator; a sensor; a diode; a keyboard; an input device; a relay; a switch; and a pixel.

22. The process of claim 19, wherein the at least one electrical component that is physically mounted onto the substrate is selected from the group consisting of an integrated circuit, a high-precision resistor, a high-precision capacitor, an inductor, a transistor, an oscillator, a crystal, a connector, a sensor, an LED, a ferrite, a switch, a filter, a jumper, and a battery.
